(19) United States
(12) Patent Application Publication
(10) Pub. No.: US 2018/0106098 A1
(43) Pub. Date: Apr. 19, 2018

(54) WINDOW ASSEMBLY WITH SELECTABLE TINT

(71) Applicant: DURA OPERATING, LLC, AUBURN HILLS, MI (US)

(72) Inventors: CUMHUR UNVEREN, COMMERCE TWP., MI (US); MICHAEL BERNHARD SZCZERBA, TROY, MI (US)

(21) Appl. No.: 15/296,400

(22) Filed: Oct. 18, 2016

(51) Int. Cl. E06B 9/24; H05B 33/08; G02F 1/01; H05B 37/02

(52) U.S. Cl. CPC E06B 9/24; H05B 33/0896; G02F 1/0121; E06B 2009/2464; G02F 2203/01; E06B 2009/2417; H05B 37/0218

(57) ABSTRACT

A window tint system for a motor vehicle includes a transparent layer and a transparent organic light emitting diode (T-OLED) screen positioned in contact with the transparent layer. The T-OLED screen includes a plurality of pixels, and the T-OLED screen has a first state wherein the pixels are substantially transparent and a second state wherein a subset of the pixels have a reduced transparency relative to the first state to reduce the transmission of light there through.

### FIELD

The invention relates generally to window assemblies in motor vehicles, for example windshields, having a transparent organic light emitting diode screen with selectable tint patterns.

### BACKGROUND

The statements in this section merely provide background information related to the present disclosure and may or may not constitute prior art.

Motor vehicle windows, which generally include rear windows, side windows, panel windows, and front windshields, are typically made from glass or a polymer. To reduce glare from the environment, such as light from the sun or reflections from vehicles, window tint may be physically applied to the window in order to reduce the transparency of the window. In one example, a window tint film may be applied to a surface of the window to block light, heat, etc. While these tint films are useful for their intended purpose, there is room in the art for more advanced window tint systems that provide customizable tinting options.

### SUMMARY

According to several aspects, a window tint system for a motor vehicle is provided. The window tint system includes a transparent layer and a transparent organic light emitting diode (T-OLED) screen positioned in contact with the transparent layer. The T-OLED screen includes a plurality of pixels, and the T-OLED screen has a first state wherein the pixels are substantially transparent and a second state wherein a subset of the pixels have a reduced transparency relative to the first state to reduce the transmission of light there through.

In one aspect, the T-OLED screen switches between the first state and the second state in response to a vehicle operator input or a vehicle input.

In another aspect, the transparent layer forms an outer surface of a forward windshield of the motor vehicle and the T-OLED screen extends continuously from a top frame of the window to a bottom frame of the window, and from a driver's left side frame of the window to a driver's right side frame of the window.

In another aspect, when in the second state, the pixels are less transparent proximate a top of the window and more transparent proximate a bottom of the window.

In another aspect, when in the second state, the pixels are less transparent proximate a first side of the window and more transparent proximate a second side of the window.

In another aspect, when in the second state, a first portion of the T-OLED screen has pixels that are less transparent and a second portion of the T-OLED screen has pixels that are more transparent, and the transparency of the pixels transitions at a continuous gradient from the first portion to the second portion.

In another aspect, when in the second state, a first portion of the T-OLED screen has pixels that are less transparent and a second portion of the T-OLED screen has pixels that are more transparent, and the first portion of the T-OLED screen is a defined by a continuous edge and at least a portion of the continuous edge is adjacent to the second portion.

In another aspect, a vehicle operator selects from the first state and the second state using an input device that generates a vehicle operator input.

In another aspect, a display controller is in communication with the T-OLED screen and at least one sensor is in communication with the display controller.

In another aspect, the sensor generates a vehicle input and the display controller selects from the first state and the second state based on the vehicle input.

In another aspect, the sensor is a light sensor and the vehicle input includes light intensity, and a degree of transparency applied by the T-OLED screen to the pixels is a function of the light intensity.

In another aspect, the sensor is a camera in communication with a perception controller configured to determine light intensity location relative to the T-OLED screen, the perception controller in communication with the display controller, and wherein the display controller dynamically changes a transparency of the pixels based on the light intensity location relative to the T-OLED screen.

According to several other aspects, a window tint system for a motor vehicle includes a sensor configured to sense a light intensity, an input device for selecting a tint preference, a transparent organic light emitting diode (T-OLED) screen having a plurality of pixels tintable to change a transparency of the pixels, a display controller in communication with the sensor, the input device, and the T-OLED screen, the display controller having memory for storing control logic and a processor configured to execute the control logic, the control logic including a first control logic for calculating an area of the OLED screen to tint based on the selected tint preference and a second control logic for calculating a degree of tint based on the light intensity.

In one aspect, a transparent layer is positioned in contact with the T-OLED screen.

In another aspect, the transparent layer forms an outer surface of a forward windshield of the motor vehicle.

In another aspect, the area of the T-OLED screen to tint is selected from one of a gradient fade out tint from a top of the T-OLED screen to a bottom of the T-OLED screen, a gradient fade out tint from a driver's left side of the T-OLED screen to a driver's right side screen, a non-gradient partial area T-OLED screen tint, and a non-gradient whole area T-OLED screen tint.

In another aspect, a plurality of cameras are in communication with the display controller, and the display controller includes a third control logic for calculating a pixel tint area and a pixel tint degree based on visual data received from the plurality of cameras in real time.

In another aspect, the display controller includes a fourth control logic for increasing a contrast of the T-OLED screen based on the light intensity or a user input.

In another aspect, the display controller includes a fifth control logic for limiting the degree of tint based on an operating condition of the motor vehicle.

According to several other aspects, a window tint system for a motor vehicle includes a light sensor configured to sense a light intensity, an input device for selecting a tint preference, a transparent layer, a transparent organic light emitting diode (T-OLED) screen positioned in contact with the transparent layer, the T-OLED screen having a plurality of tintable pixels, a display controller in communication with the light sensor, the input device, and the T-OLED screen, wherein the display controller is configured to dynamically calculate a pixel tint configuration for the T-OLED screen based on the selected tint preference and on the light intensity.

Further aspects, examples, and advantages will become apparent by reference to the following description and appended drawings wherein like reference numbers refer to the same component, element or feature.

### DRAWINGS

The drawings described herein are for illustration purposes only and are not intended to limit the scope of the present disclosure in any way.

FIG. 1 is a top diagrammatic view of a window tint system in an exemplary motor vehicle according to aspects of the present disclosure;

FIG. 2 is a cross sectional side elevational view of a display screen according to aspects of the present disclosure;

FIG. 3 is a cross sectional side elevational view of a display screen according to further aspects of the present disclosure;

FIG. 4 is a front interior view of a motor vehicle windshield having the window tint system in a first configuration;

FIG. 5 is a front interior view of a motor vehicle windshield having the window tint system in a second configuration; and

FIG. 6 is a front interior view of a motor vehicle windshield having the window tint system in a third configuration.

### DETAILED DESCRIPTION

The following description is merely exemplary in nature and is not intended to limit the present disclosure, application, or uses.

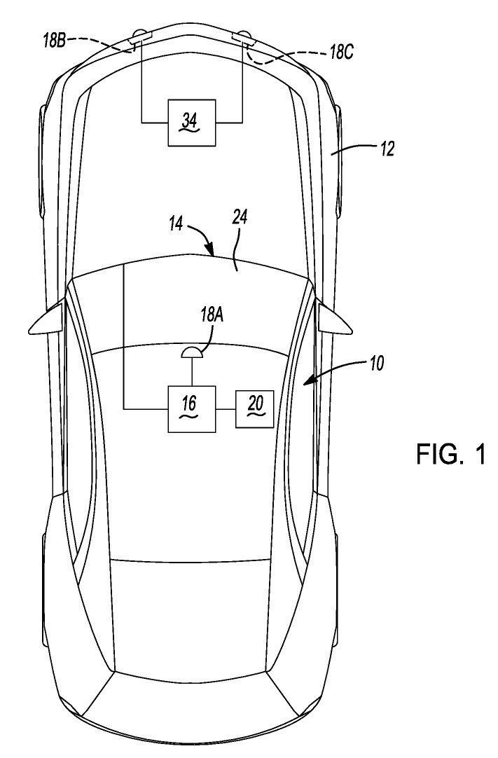

With reference to FIG. 1, a window tint system is generally indicated by reference number 10. The window tint system 10 is shown illustrated with an exemplary motor vehicle 12. The motor vehicle 12 is illustrated as a passenger vehicle, however, the motor vehicle 12 may be a truck, sport utility vehicle, van, motor home, or any other type of vehicle without departing from the scope of the present disclosure. The window tint system 10 includes a window display 14, a display controller 16, one or more sensors 18A-C, and a manual input system 20.

In the example provided, the window display 14 is configured as a front windshield of the motor vehicle 12. However, it should be appreciated that the window display 14 may be configured as side windows, a rear window, panel windows, or any combination thereof. The window display 14 includes a substantially transparent organic light emitting diode (T-OLED) screen 22 which is positioned on or adjacent to at least one vehicle exterior pane 24 of the window display 14. The T-OLED screen 22, generally speaking, incudes a light-emitting diode (LED) in which a substantially transparent emissive electroluminescent layer comprised of pixels emits light or reduces transparency there through in response to an electric current from the display controller 16. This transparent emissive electroluminescent layer, otherwise known as an organic semiconductor, is situated between two electrode films. In one aspect, both the electrode films are also transparent thus rendering the display screen 14 transparent under certain operating conditions. The vehicle exterior pane 24 may be a glass pane or a transparent polymer, depending on the location of the window display 14.

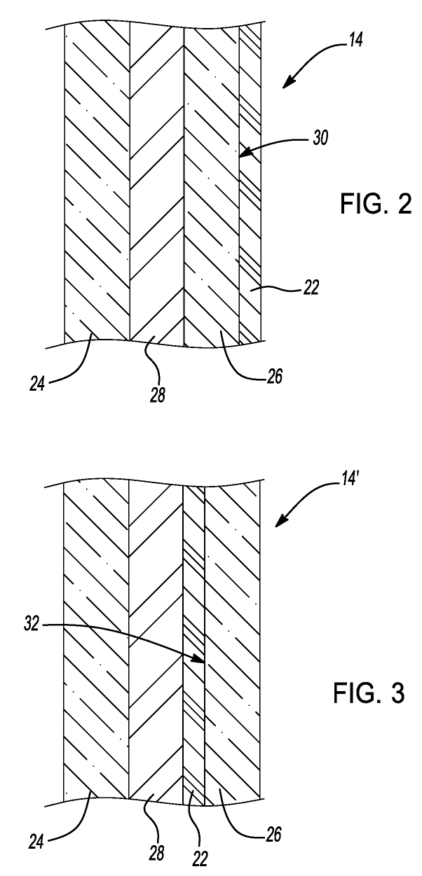

For example, FIG. 2 illustrates a first embodiment of the window display 14 where the T-OLED screen 22 is mounted to a vehicle interior pane 26. The vehicle interior pane 26 is mounted to the vehicle exterior pane 24 by a layer of polymeric material 28 positioned between the panes 24, 26. In this aspect, the T-OLED screen 22 is positioned on and in direct contact with an interior directed face 30 of the vehicle interior pane 26, thereby protecting the T-OLED screen 22 from exterior environmental conditions, while exposing the T-OLED screen 22 to the vehicle interior environment.

Turning to FIG. 3, a second embodiment of a window display is indicated by reference number 14′. In the window display 14′, the T-OLED screen 22 is mounted between the panes 24, 26. For example, the T-OLED screen 22 is positioned on and in direct contact with an exterior directed face 32 of the vehicle interior pane 26. The T-OLED screen 22 and the vehicle interior pane 26 are mounted to the vehicle exterior pane 24 by the layer of polymeric material 28. Thus the T-OLED screen 22 is protected from both the exterior environmental conditions and the vehicle interior conditions. It is noted the T-OLED screen 22 can alternately be positioned between the vehicle exterior pane 24 and the layer of polymeric material 28.

Returning to FIG. 1, the T-OLED screen 22 is in electronic communication the display controller 16. The display controller 16 is configured to control the T-OLED screen 22 by selectively energizing pixels within the T-OLED screen 22 based on one or more inputs received by the display controller 16. The display controller 16 is a non-generalized, electronic control device having a preprogrammed digital computer or processor, memory or non-transitory computer readable medium used to store data such as control logic, instructions, image data, lookup tables, etc., and a plurality of input/output peripherals or ports. The processor is configured to execute the control logic or instructions. The display controller 16 may have additional processors or additional integrated circuits in communication with the processor.

The display controller 16 is in electronic communication with the one or more sensors 18 and the manual input system 20. The sensors 18 may include a light sensor and/or one or more cameras mounted to the motor vehicle 12. In one example, a light sensor 18A is disposed proximate the window display 14. The light sensor 18A is configured to sense or detect light intensity. Light intensity is communicated to the display controller 16. In another example, the sensors 18 include at least two forward facing cameras 18B, 18C mounted on the motor vehicle 12. The forward facing cameras 18B, 18C are configured to capture visual information. In one aspect, the forward facing cameras 18B, 18C permit triangulation of light sources in front of the motor vehicle 12. The visual information may be communicated to the display controller 16 or processed in a visual processing or perception controller 34 associated with the camera or in a body control module, advanced driver assistance system controller, or any other controller. Processed visual data may then be communicated to the display controller 16 or command instructions may be communicated to the display controller 16. It should be appreciated that the window tint system 10 may have only the light sensor 18A, only one or more of the forward facing cameras 18B, 18C, or all of the sensors 18A-C.

The manual input system 20 is configured to receive manual inputs from a user of the motor vehicle 12. The manual input system 20 is a human machine interface (HMI) device mounted within the motor vehicle 12 and accessible by an occupant of the motor vehicle 12. For example, the manual input system 20 may include a touch screen, switches, knobs, combinations thereof, etc.

The window tint system 10 operates to manually or automatically adjust the transparency, or tint, of the window display 14 by selectively adjusting the transparency of the T-OLED screen 22 in order to reduce the transmission of environmental light there through. In one example, the light sensor 18A detects the light intensity of the environment in which the motor vehicle 12 is operating. The light intensity is communicated to the display controller 16. The display controller 16 then commands the T-OLED screen 22 to reduce the transparency of all, or a subset of all, the pixels that make up the T-OLED screen 22 based on the light intensity. The level of reduced transparency can be adjusted from a normal or near full transparency state to a substantially opaque state and/or any transparency states in-between automatically based on the light intensity or manually using the manual input system 20. Additionally, the color of the tint may be adjusted. Moreover, the subset of pixels that are tinted can be set automatically by the display controller 16 or selected by a user via the manual input system 20. In one aspect, the display controller 16 tints a subset of pixels localized around a light source dynamically, or in real-time, based on triangulated visual data from the first and second cameras 18B, 18C. Thus, as the location of the light source changes relative to the display screen 14, the subset of pixels that are tinted moves to track the light source. In another aspect, the display controller 16 may adjust the contrast of the T-OLED screen 22 based on the sensed light intensity or a user input. Finally, the display controller 16 may limit the amount of tint provided by the T-OLED screen based on other vehicle factors, such as vehicle speed, advanced driver assistance systems, etc.

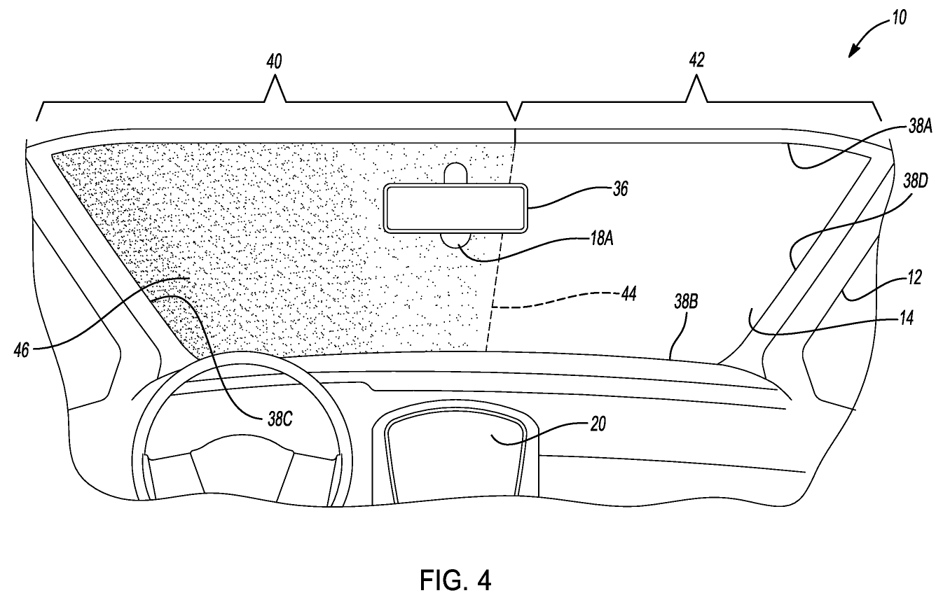

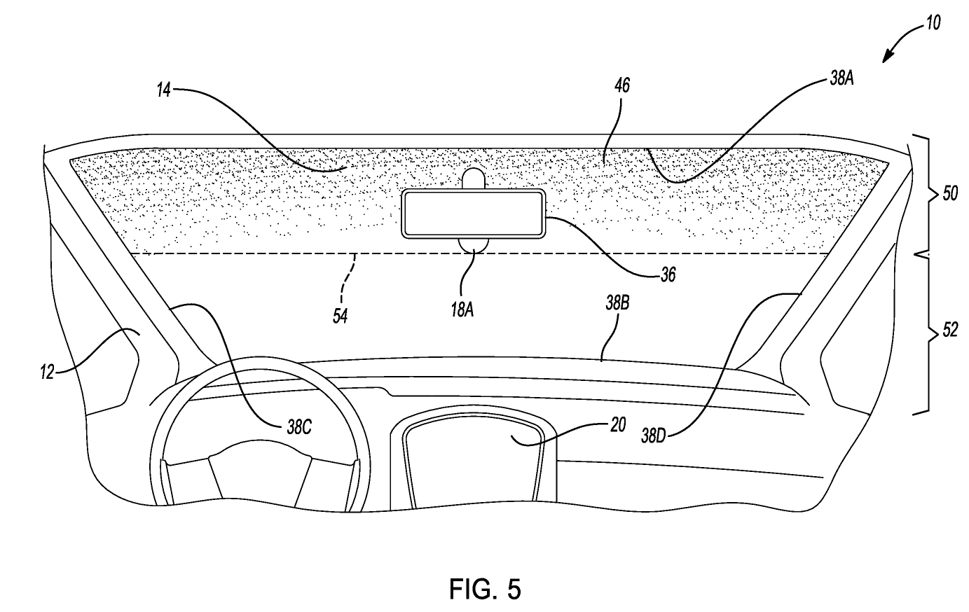

Turning to FIG. 4, an example of a tint state of the window display 14 is shown from the perspective of an interior of the motor vehicle 12. The window display 14, and thus the T-OLED screen 22, extends continuously from a top frame 38A of the window to a bottom frame 38B of the window, and from a driver's left side frame 38C of the window to a driver's right side frame 38D of the window. In this example, the light sensor 18A is shown mounted to a rear-view mirror 36 while the manual input system 20 is illustrated as a touchscreen control. In this tint state, the T-OLED screen 22 has been tinted in a first area 40 and has not been tinted in a second area 42. The first area 40 extends from a driver's side of the window display 14 to a vertical boundary line 44. The first area 40 includes individual pixels 46 of the T-OLED screen 22 that have been commanded by the display controller 16 to have reduced transparency relative to the second area 42. The second area 42 extends from the vertical boundary line 44 to a passenger's side of the window display 14. In one aspect, the first area 40 is tinted on a gradient from left to right as shown in FIG. 4. Thus, the transparency within the first area 40 decreases along a continuous gradient from left to right where pixels 46 have increased opacity on the left and decreased opacity on the right. Alternatively, the first area 40 may have a uniform tint. The vertical boundary line 44 may be located anywhere along the window display 14 including to the far right. Moreover, it should be appreciated that the second area 42 may be tinted while the first area 40 may remain fully transparent. The location of the vertical boundary line 44, as well as the degree of opacity of the tinted pixels 46, is selected via the manual input system 20 or automatically set by the display controller 16 based on the light intensity detected by the light sensor 18A or based on the triangulated light source detected by the cameras 18B, 18C.

Turning to FIG. 5, another example of a tint state of the window display 14 is shown from the perspective of an interior of the motor vehicle 12. In this tint state, the T-OLED screen 22 has been tinted in a first area 50 and has not been tinted in a second area 52. The first area 50 extends from a top side of the window display 14 to a horizontal boundary line 54. The first area 50 includes individual pixels 46 of the T-OLED screen 22 that have been commanded by the display controller 16 to have reduced transparency relative to the second area 52. The second area 52 extends from the horizontal boundary line 54 to a lower side of the window display 14. In one aspect, the first area 50 is tinted on a gradient from top to bottom as shown in FIG. 5. Thus, the transparency within the first area 50 decreases along a continuous gradient from top to bottom where pixels 46 have increased opacity on the top and decreased opacity on the bottom. Alternatively, the first area 50 may have a uniform tint. The horizontal boundary line 54 may be located anywhere along the window display 14 including to the bottom. Moreover, it should be appreciated that the second area 52 may be tinted while the first area 50 may remain fully transparent. The location of the horizontal boundary line 54, as well as the degree of opacity of the tinted pixels 46, is selected via the manual input system 20 or automatically set by the display controller 16 based on the light intensity detected by the light sensor 18A or based on the triangulated light source detected by the cameras 18B, 18C.

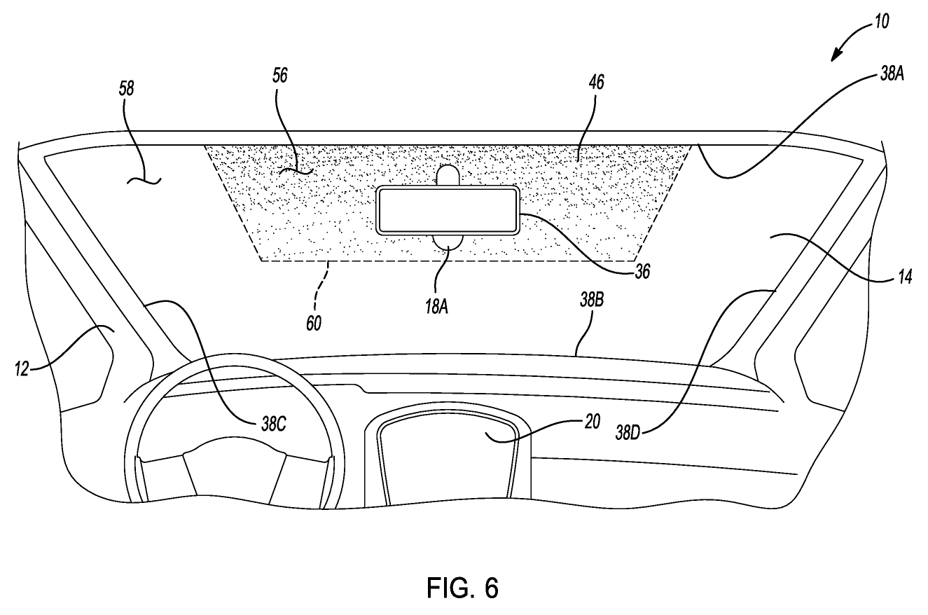

Turning to FIG. 6, another example of a tint state of the window display 14 is shown from the perspective of an interior of the motor vehicle 12. In this tint state, the T-OLED screen 22 has been tinted in a first area 56 and has not been tinted in a second area 58. The first area 56 is defined by a boundary line 60. The first area 56 may have any number of pre-configured shapes and may be located anywhere within the window display 14. Thus, the first area 56 can be rectangular as shown, or can be any geometric shape including circular, oval, square, or polygonal. In the example provided, the first area 56 extends from the top of the window display 14 but does not extend to the sides or the bottom of the window display 14. The first area 56 includes individual pixels 46 of the T-OLED screen 22 that have been commanded by the display controller 16 to have reduced transparency relative to the second area 58. The second area 58 is that portion of the window display 14 not within the first area 56. Thus the boundary line 60 provides a continuous edge between the first area 56 and the second area 58. In one aspect, the first area 56 is tinted on a gradient from top to bottom as shown in FIG. 6. Thus, the transparency within the first area 56 decreases along a continuous gradient from top to bottom where pixels 46 have increased opacity on the top and decreased opacity on the bottom. Alternatively, the first area 56 may have a uniform tint. Moreover, it should be appreciated that the second area 58 may be tinted while the first area 56 may remain fully transparent. The size and shape of the first area 56, as well as the degree of opacity of the tinted pixels 46, is selected via the manual input system 20 or automatically set by the display controller 16 based on the light intensity detected by the light sensor 18A or based on the triangulated light source detected by the cameras 18B, 18C.

The description of the invention is merely exemplary in nature and variations that do not depart from the gist of the invention are intended to be within the scope of the invention. Such variations are not to be regarded as a departure from the spirit and scope of the invention.

1. A window tint system for a motor vehicle comprising:
a transparent layer; and
a transparent organic light emitting diode (T-OLED) screen positioned in contact with the transparent layer, the T-OLED screen having a plurality of pixels, and wherein the T-OLED screen has a first state wherein the pixels are substantially transparent and a second state wherein a subset of the pixels have a reduced transparency relative to the first state to reduce the transmission of light there through.

2. The window tint system of claim 1 wherein the T-OLED screen switches between the first state and the second state in response to a vehicle operator input or a vehicle input.

3. The window tint system of claim 1 wherein the transparent layer forms an outer surface of a forward windshield of the motor vehicle and the T-OLED screen extends continuously from a top frame of the window to a bottom frame of the window, and from a driver's left side frame of the window to a driver's right side frame of the window.

4. The window tint system of claim 1 wherein, when in the second state, the pixels are less transparent proximate a top of the window and more transparent proximate a bottom of the window.

5. The window tint system of claim 1 wherein, when in the second state, the pixels are less transparent proximate a first side of the window and more transparent proximate a second side of the window.

6. The window tint system of claim 1 wherein, when in the second state, a first portion of the T-OLED screen has pixels that are less transparent and a second portion of the T-OLED screen has pixels that are more transparent, and the transparency of the pixels transitions at a continuous gradient from the first portion to the second portion.

7. The window tint system of claim 1 wherein, when in the second state, a first portion of the T-OLED screen has pixels that are less transparent and a second portion of the T-OLED screen has pixels that are more transparent, and the first portion of the T-OLED screen is a defined by a continuous edge and at least a portion of the continuous edge is adjacent to the second portion.

8. The window tint system of claim 1 wherein a vehicle operator selects from the first state and the second state using an input device that generates a vehicle operator input.

9. The window tint system of claim 1 further comprising a display controller in communication with the T-OLED screen and at least one sensor in communication with the display controller.

10. The window tint system of claim 9 wherein the sensor generates a vehicle input and the display controller selects from the first state and the second state based on the vehicle input.

11. The window tint system of claim 10 wherein the sensor is a light sensor and the vehicle input includes light intensity, and a degree of transparency applied by the T-OLED screen to the pixels is a function of the light intensity.

12. The window tint system of claim 9 wherein the sensor is a camera in communication with a perception controller configured to determine light intensity location relative to the T-OLED screen, the perception controller in communication with the display controller, and wherein the display controller dynamically changes a transparency of the pixels based on the light intensity location relative to the T-OLED screen.

13. A window tint system for a motor vehicle comprising:
a sensor configured to sense a light intensity;
an input device for selecting a tint preference;
a transparent organic light emitting diode (T-OLED) screen having a plurality of pixels tintable to change a transparency of the pixels;
a display controller in communication with the sensor, the input device, and the T-OLED screen, the display controller having memory for storing control logic and a processor configured to execute the control logic, the control logic including a first control logic for calculating an area of the T-OLED screen to tint based on the selected tint preference and a second control logic for calculating a degree of tint based on the light intensity.

14. The window tint system of claim 13 further comprising a transparent layer positioned in contact with the T-OLED screen.

15. The window tint system of claim 14 wherein the transparent layer forms an outer surface of a forward windshield of the motor vehicle.

16. The window tint system of claim 13 wherein the area of the T-OLED screen to tint is selected from one of a gradient fade out tint from a top of the T-OLED screen to a bottom of the T-OLED screen, a gradient fade out tint from a driver's left side of the T-OLED screen to a driver's right side screen, a non-gradient partial area T-OLED screen tint, and a non-gradient whole area T-OLED screen tint.

17. The window tint system of claim 13 further comprising a plurality of cameras in communication with the display controller, and wherein the display controller includes a third control logic for calculating a pixel tint area and a pixel tint degree based on visual data received from the plurality of cameras in real time.

18. The window tint system of claim 13 wherein the display controller includes a fourth control logic for increasing a contrast of the T-OLED screen based on the light intensity or a user input.

19. The window tint system of claim 13 wherein the display controller includes a fifth control logic for limiting the degree of tint based on an operating condition of the motor vehicle.

20. A window tint system for a motor vehicle comprising:
a light sensor configured to sense a light intensity;
an input device for selecting a tint preference;
a transparent layer;
a transparent organic light emitting diode (T-OLED) screen positioned in contact with the transparent layer, the T-OLED screen having a plurality of tintable pixels; and
a display controller in communication with the light sensor, the input device, and the T-OLED screen, wherein the display controller is configured to dynamically calculate a pixel tint configuration for the T-OLED screen based on the selected tint preference and on the light intensity.
